(19) United States
(12) Patent Application Publication
(10) Pub. No.: US 2013/0117179 A1
(43) Pub. Date: May 9, 2013

(54) Methods and Systems for Ad Hoc Intellectual Property Annuity/Maintenance Payments

(71) Applicant: Thomson Reuters (Scientific) Inc., Philadelphia, PA (US)

(72) Inventors: Renee M. Darragh, Northville, MI (US); Adam E. Kenney, FREDERICK, MD (US); John S. Ryan, Lake Orion, MI (US); Joseph W. Kaye, JR., ROCHESTER HILLS, MI (US); Jeffrey A. Kesek, New Baltimore, MI (US); STEPHANIE S. Emanuel, Novi, MI (US)

(73) Assignee: THOMSON REUTERS (SCIENTIFIC) INC., Philadelphia, PA (US)

(21) Appl. No.: 13/724,128

(22) Filed: Dec. 21, 2012

Related U.S. Application Data
(63) Continuation-in-part of application No. 12/380,578, filed on Feb. 28, 2009.

(51) Int. Cl. G06Q 20/14

(52) U.S. Cl. CPC G06Q 20/14; G06Q 50/184
USPC 705/40

(57) ABSTRACT

The invention relates to an automated computer implemented system and method that eliminates or at least reduces the possibility that rights associated with a piece of IP, such as a patent, trademark, patent application, and/or trademark application will be forfeited due to failure to pay a maintenance fee or annuity.

### CROSS-REFERENCE TO RELATED APPLICATIONS

This application is a continuation-in-part application and claims priority to Published U.S. Patent Application No. 2010/0223557 (application Ser. No. 12/380,578) filed Feb. 28, 2009 entitled “Method and System for Workflow Integration” bearing named inventors Adam Kenney, Phillip Henderson, and Jeffrey A. Thompson (hereinafter “IPM application”). This application is also related to U.S. patent application Ser. No. ______, filed concurrently herewith, entitled “Intellectual Property Annuity/Maintenance Payment and Mistaken Abandonment Prevention Systems and Methods” naming Renee M. Darragh, Joseph W. Kaye, Jr., Adam E. Kenney, Jeffrey A. Kesek, Shilpa Kommidi, John S. Ryan, and Brandon E. Varilone as inventors (hereinafter “abandonment prevention application” or “APA”) and referenced by Attorney Docket IPS(IP)_{—}009_US1. Both the IPM application and the APA application are herein incorporated by reference as if set forth in their entirety.

### FIELD OF THE INVENTION

The invention relates to intellectual property (“IP”) docketing systems and methods. More particularly, the invention relates to systems and methods for accounting for the movement of IP during certain time periods to ensure that IP is not inadvertently abandoned.

### BACKGROUND

Many entities own IP. These entities include both individuals and corporations. Patents and trademarks are two types of IP for which an application may be submitted to a governmental agency, an examination conducted, and an enforceable right (e.g., an issued patent or trademark) granted to an entity. Service marks are another type of IP. Unless otherwise noted, as used herein, trademarks include both service marks and trademarks and trademark applications include both service mark applications and trademark applications.

Many large entities, such as publicly traded companies, have large IP portfolios requiring attention. Non-publically traded entities, such as law firms, manage IP portfolios on behalf of numerous clients, ranging from large publicly traded companies to individuals. In these situations, law firms provide the attention necessary to affect the goals of each client.

The attention required by patents and trademarks includes decisions as to whether to make annuity and/or maintenance payments. Sometimes the IP owner decides to let the IP lapse by, e.g., failing to make a payment due. This decision may be due to, e.g., the owner no longer needing the IP in a particular country, the cost/benefit analysis of retaining the IP, or some other reason. Sometimes, however, IP will lapse due to a mistake. In these situations, the IP owner may seek to be compensated not only for the money, time and effort to attempt to revive the IP that has lapsed but also the value of the IP itself if, e.g., the attempt to revive is unsuccessful. Even if the revival is successful, the IP owner may seek compensation if the piece of IP has diminished in value due to, e.g., “intervening rights” of a third party. The compensation the IP owner may seek from the entity (e.g., law firm) making a mistake in docketing or other error in communication or instruction is related to the value of the forfeited IP, at least in cases wherein the attempt to revive is unsuccessful. Thus, an entity mistakenly permitting the Coca Cola® trademark or Lipitor® patent in the United States to lapse will have more legal exposure than an entity mistakenly permitting a lesser know trademark or patent associated with a lesser know product to lapse.

Thomson Reuters' Thomson IP Manager® is used by many entities to ensure, among other things, that their IP is protected and preserved and that decisions as to whether to make annuity and/or maintenance payments are made in a timely fashion. Thomson IP Manager® is an enterprise-level intellectual asset management solution which gives an IP owner the power to enable collaboration between departments and the speed with which to make decisions to protect critical IP assets. The IPM application describes systems and methods for creating, defining, and performing IP related workflow.

Despite an IP owner using an entity (e.g., Thomson IP Management Services, a law firm, etc. . . . ) as an agent to make annuity and/or maintenance payments, the IP owner is still vulnerable, during certain timeframes, to the mistaken and/or inadvertent lapsing of IP through no fault of the entity serving as the agent. In these unfortunate situations, it is harder for the IP owner to seek compensation for the loss or diminished value of the IP because the fault typically lies with a person, or a group of people, employed by the IP owner as opposed to an agent of the IP owner.

### SUMMARY

We have recognized that the need to account for the movement of IP during certain timeframes in order to ensure IP does not inadvertently or mistakenly lapse due to failure to make a maintenance or annuity payment. Particularly troublesome are certain timeframes associated with, e.g., a merger of businesses, an acquisition of a business, a divestiture of a business, the sale of a piece of IP, and/or the purchase of a piece of IP. More specifically, we have recognized that there is an increased opportunity to preserve rights associated with the piece of IP involved in a transaction during a certain timeframe through automated computer implemented systems and methods that: (1) identify a time period prior to a first time; (2) based on the time period, generate a set of payment decisions for which a set of payment responses is due and is associated with the time period, the set of payment decisions being associated with a first set of intellectual property, the first set of intellectual property being associated with an IP docketing system; (3) during a timeframe, detect a change at a second time, the change impacting the set of payment decisions, the second time being after the first time and prior to the beginning of the time period; (4) determine that the change has rendered the set of payment decisions inaccurate; (5) based on the change, generate an electronic signal indicative of an updated set of payment decisions for which an updated set of payment responses is due and is associated with the time period, the updated set of payment decisions being associated with a second set of intellectual property; and 6) transmit the electronic signal.

Advantageously, the present invention eliminates, or at least reduces, the possibility that the current owner of a piece of IP will mistakenly or inadvertently fail to pay a maintenance fee and/or annuity payment in a timely fashion.

Also advantageously, the present invention eliminates, or at least reduces, the possibility that the former owner of a piece of IP will pay a maintenance fee and/or annuity for which the former owner is not responsible.

Additional advantages and/or features of the present invention will be set forth in part in the description. It is to be understood that both the foregoing general description and the following detailed description of the present invention are exemplary and explanatory and are intended to provide further explanation of the present invention as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. In order to facilitate the understanding of the present invention, reference is made to the figures below in which like elements are referenced with like numerals. In order to avoid any potential confusion with the IPM application and the APA application, the reference numerals in this application will begin with reference numeral 6100. To the extent any reference numbers conflict between this application and the IPM application and/or the APA application, this application controls. Further, reference numerals having a value below 5100 refer to the IPM application and reference numerals having a value from 5100 through 5999 refer to the APA application.

FIG. 1 is a diagram of a Thomson IP Manager® module (“IPMM”) 6100, in addition to other elements, residing on server 6102 at client system 106;

FIG. 2 is a diagram of an ad hoc module 6105 of the AMS 104;

FIG. 3 is a diagram of the timing of events that may be associated with both the APA and this patent application;

FIG. 4 shows an embodiment of how various ad hoc pieces of IP may be handled;

FIGS. 5a through 5d illustrate exemplary screen shots and user interface elements associated with FIG. 4 and a second embodiment of how various ad hoc pieces of IP may be handled; and

FIG. 6 is a flowchart representing the process by which the ad hoc decisions of a client are processed by an IP payment services provider.

### DETAILED DESCRIPTION OF THE EXEMPLARY EMBODIMENT

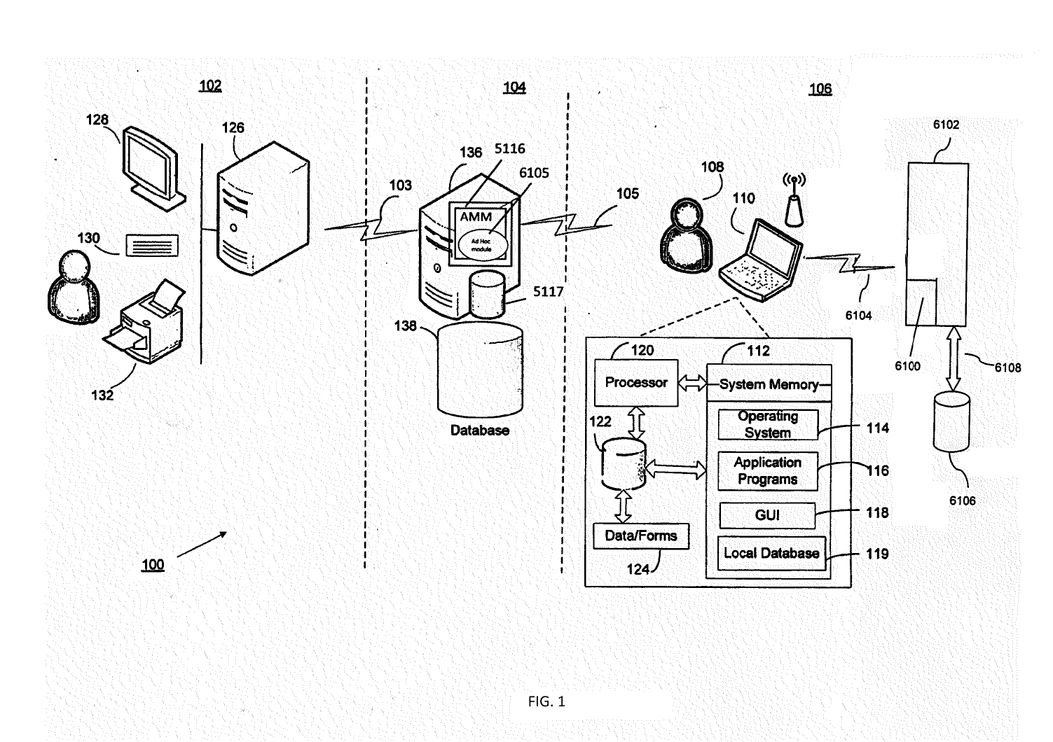

Referring to FIG. 1, IPMM 6100 is part of a server 6102 which is part of a client system 106. The server 6102 is shown as being able to communicate with a user 108 of a computer 110 at a client site 106 via communication link 6104. Thus, the server 6102 is capable of providing access to, among other things, an internally hosted solution for a client 5304. The user 108 is also, through computer 110, able to communicate with AMS 104 via communication link 105. As far as the client 5304 is concerned, AMS 104 is an externally hosted solution serving many clients. The AMS 104 has an ad hoc module 6105 within it.

Throughout this description and by way of example only, both the internally hosted solution of the client 5304 (e.g., Thomson IP Manager®) and the externally hosted solution (e.g., Connected IP Payments) may be supplied by a single entity such as Thomson Reuters IP Solutions (“TRIPS”). The client 5304 may desire to host Thomson IP Manager® internally because there is sensitive information contained in, e.g., database 6106 which is in communication with server 6102 via bus 6108. However, as TRIPS services multiple clients (see, e.g., client systems 102 and 106) with Connected IP Payments, it is more practical to have Connected IP Payments hosted for a client 5304. Having an IP payment services provider host an annuity payment solution is generally described and referred to in the APA. As used herein, the terms “annuity,” “annuity fee”, “annuity payment”, “renewal”, “maintenance”, “maintenance payment,” and “maintenance fee,” and any and all forms thereof, are used interchangeably and refer to a payment due and/or made in order to preserve a piece of IP. Multiple users (not shown) having authority to access client system 106 using various computers (not shown) will be able to communicate with the server 6102 and the IPMM thereof. Likewise, multiple users of another TRIPS client associated with client system 102 will not be able to communicate with server 6102 but may, instead, have their own server (not shown) to host their version of an IP docketing system such as Thomson IP Manager® supplied by TRIPS. Thus, it is clear that for purposes of this application, the users associated with client system 102 are employees and/or agents of a separate entity that the users associated with client system 106.

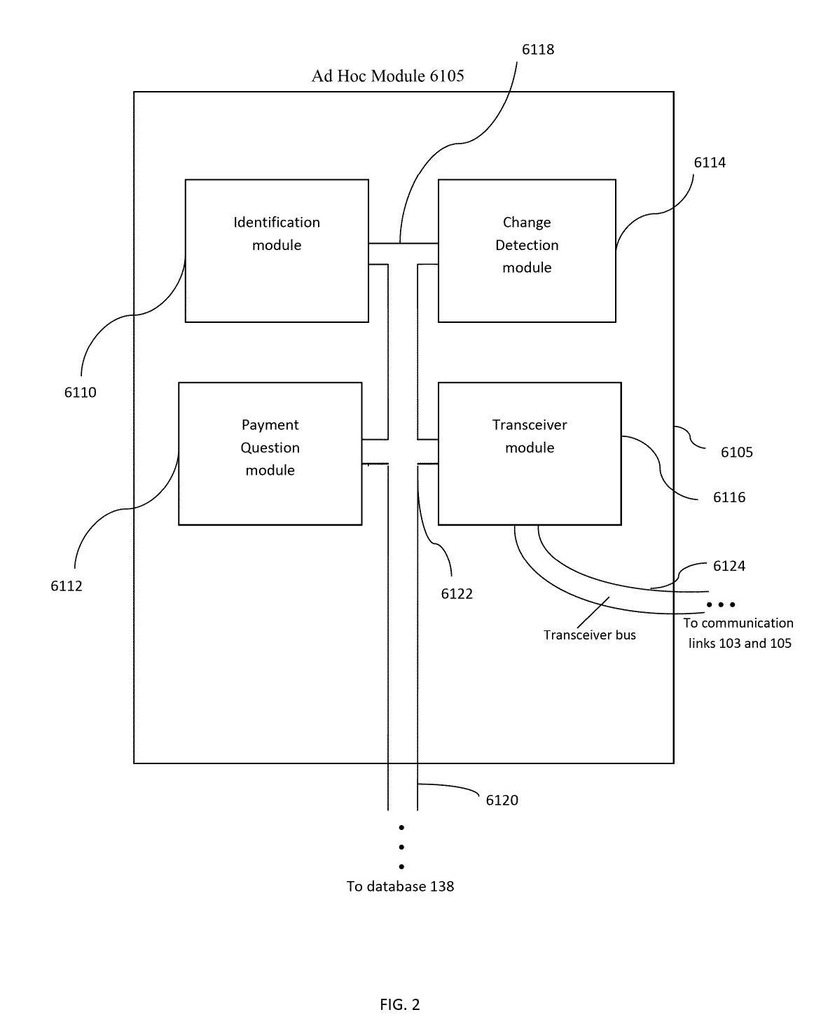

Referring to FIG. 2, the ad hoc module 6105 of the AMS 104 is comprised of an identification module 6110, a payment question module 6112, a change detection module 6114, and a transceiver module 6116. Communications bus 6118 serves to interconnect the identification module 6110, the payment question module 6112, the change detection module 6114, and the transceiver module 6116. The communications bus 6118 is also connected to bus 6120 at point 6122. Bus 6120 transfers information between the ad hoc module 6105 and the database 138. The transceiver module 6116 is communicably coupled, though not necessarily directly connected, to communication links 105 and 103 via transceiver bus 6124. The database 138 is used to manipulate data stored in memory as will be discussed herein. While the AMS 104 may be written in a variety of computer languages, preferably, it is written in a object oriented language such as C#. The databases referred to herein may also be deployed upon a variety of platforms, preferably on an industry standard enterprise platform such as a Microsoft SQL server. The AMS 104 may be hosted on one or more industry standard file servers such as Intel-based enterprise class file servers or their virtual machine equivalents.

From the perspective of the client 5304, the first embodiment of this detailed description is explained in the context of the payment system (e.g., the Connected IP Payments) being externally hosted and the IP docketing system (e.g., Thomson IP Manager®) being internally hosted. However, those skilled in the art will appreciate that there are many embodiments that may be used to practice the invention. For example, a second embodiment may entail the client 5304 interacting with the AMS 104 without necessarily needing the IP docketing system. Also, in a third embodiment, the IP docketing system and the payment system, regardless of the hosting situation, may be able to communicate directly with each other. In fact, they may be integrated into a single system. Further, both the IP docketing system and the payment system may be externally hosted, especially for a client 5304 less concerned about an IP payment services provider 5306 having access to certain data and information.

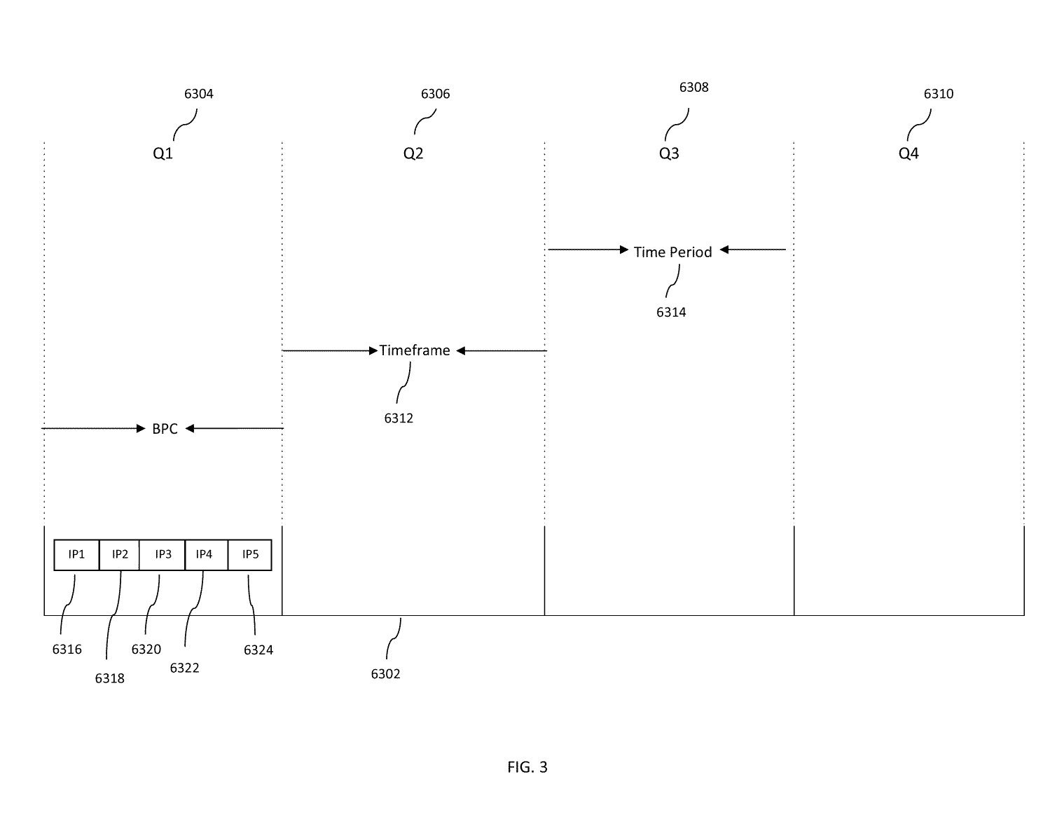

FIG. 3 is an exemplary diagram of timing events. As shown, a year 6302 is divided into a first quarter 6304, a second quarter 6306, a third quarter 6308 and a fourth quarter 6310. In this example, the client 5304 of the IP payment service provider 5306 uses the BPC on a quarterly basis. Further, the client 5304 is using the payment system (e.g., Connected IP Payments) in the first quarter 6304 of the year 6302 to authorize payments due in a third quarter 6308 of the year 6302. This is typical because, as discussed in the APA, this allows the IP payment services provider 5306 sufficient time (e.g., the second quarter 6306 in this example) to make payments, retain agents to make payments if necessary, verify all authorized payments have been made, and report back to the client 5304. In this example, the BPC is in the first quarter 6304, the timeframe 6312 is in the second quarter 6306, and the time period 6314 is the third quarter 6308. Further, a first time at which the time period is identified occurs during the first quarter 6304. This is because, in this example, the BPC occurs during the first quarter 6304. Further the first time may be considered to be any time at which the third quarter (the “time period 6314” in this example) is identified. Thus, in this example, the first time may be considered to be: (a) the time in the IDC 5402 wherein the AMS 104 generates the initial decision list based upon the extraction file; (b) the time in the FDC 5404 wherein the AMS 104 generates the final decision list based upon the final extraction file; (c) or any time after the time designated in (a) and prior to the end of the BPC.

Again referring to FIG. 3 and continuing with the example, assume the client 5304 is in the FDC 5404 stage of the BPC and provides an extract to the IP payment services provider 5306 from which a final extraction file is generated as discussed in the APA. Further assume that based upon the final extraction file and the FDC 5404, the client 5304 is ultimately exposed to five records when logging into the AMS 104 during the first quarter 6304. Further assume the five records are for IP1 6316, IP2 6318, IP3 6320, IP4 6322, and IP5 6324 and relate to a Japanese trademark application, a Japanese patent, a U.S. patent, a U.S. trademark, and a U.S. patent application bearing a VIP designation, respectively. In terms of assumptions, further assume that in this example, the client 5304 uses the AMS 104 to instruct the IP payment services provider 5306 to pay the annuities due on IP1 6316, IP2 6318, IP3 6320, and IP4 6322, keeping in mind that a payment decision need not be made by the client 5304 with respect to IP5 6324 because it bears a VIP designation.

Yet again referring to FIG. 3 and continuing with the example above, assume the DCS 5406 is complete, signifying an end to the BPC. In this example, as shown in FIG. 3, this occurs on March 31^{st} (the end of the first quarter 6304). Assume further that during the timeframe 6312, the client 5304 divests is business in Japan, including all IP assets such as IP1 6316 and IP2 6318. Further assume that during the timeframe 6312, the client 5304 acquires two new pieces of IP, namely IP6 6326 and IP7 6328 which relate to a Canadian patent and a Canadian trademark, respectively. Further assume that IP6 6326 does not have an annuity due during the time period and that IP7 6328 has a renewal due during the time period. Those skilled in the art will appreciate that the timeframe 6312 consists of a contiguous block of time beginning at any time after the first time and ending prior to the date on which a decision and payment are due for the earliest piece of IP in order to prevent lapsing. Preferably, the timeframe 6312 runs from the time immediately after the first time until the beginning of the time period 6314.

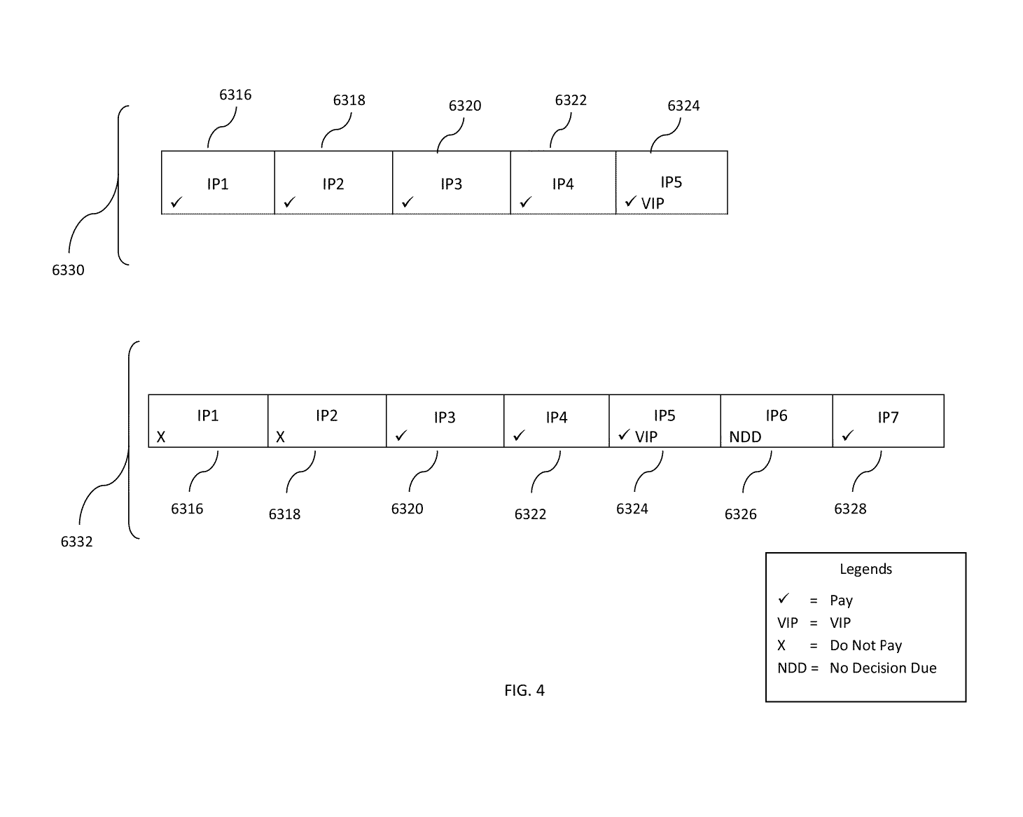

Referring to FIG. 4, the client 5304 wants to ensure that the authorization previously provided to the IP payment services provider 5306 reflects the new business conditions of the client 5304 which occurred after the BPC. More specifically, the client no longer desires to pay annuities on IP that was divested (i.e., IP1 6316 and IP2 6318) and desires to make decisions on whether or not to pay annuities on IP which was newly acquired (i.e., IP6 6326 and IP7 6328). FIG. 4 shows a set of legends 6334 associated with authorizations from the client after the BPC (designated in bracket 6330) and after the ad hoc process (designated in bracket 6332). The ad hoc process entails the client 5304 using a computer-based system such as server 6102 to generate an ad hoc extraction file using the data in database 6106. The ad hoc extraction file is sent via communication link 6104, computer 110, and communication link 105 to AMS 104 of an IP payment services provider 5306. In a fashion similar to that described with respect to the IDC 5402 and the FDC 5404, the AMS 104, having received the ad hoc extraction file, generates an updated set of payment decisions by applying the most current set of IP rules in a fashion similar to that explained with respect to the IDC 5402 and the FDC 5404. This updated set of payment decisions is generated during the timeframe 6312 and, more specifically, during a second time which may be any time during the timeframe 6312. The AMS 104 accomplishes this by detecting that an IP docketing system such as Thomson IP Manager® has changed. In this example, the AMS 104 detects this change by analyzing the data in the ad hoc extraction file from the IP docketing system at client site 106. The AMS 104 is able to discern that the IP docketing system has had a number of records impacted due to new business conditions or due to the laws or rule calculations applicable to the records. Having generated the updated set of payment decisions and transmitted it to the portion of the AMS 104 denoted by reference numeral 136, the AMS 104 provides the client 5304 with notification of such events, permitting the client 5304 to log into the AMS 104 to view and act upon the updated set of payment decisions. As will be appreciated by those skilled in the art, the updated set of payment decisions is associated with a second set of intellectual property whereas the set of payment decisions is associated with the first set of intellectual property. Further, by way of example only, one could consider an association to be the relationship between the updated set of payment decisions and: (1) all of the pieces of IP in Thomson IP Manager® when the updated set of payment decisions is generated; (2) only the pieces of IP existing in Thomson IP Manager® after the new business conditions are reflected for which a payment is due during the time period 6314; or (3) all of the pieces of IP for which there was a change to the record in Thomson IP Manager® due to the new business conditions. Likewise, similar associations may be drawn between the set of payment decisions and the first set of intellectual property.

Again referring to FIG. 4, based upon the new business conditions, the client, during the ad hoc process, has the ability to remove authorization to pay annuities on IP1 6316 and IP2 6318 and add authorization to pay an annuity on IP7 6328 (keeping in mind that newly acquired IP6 6326 has no decision due at this time) as designated within bracket 6332. This permits the client 5304 to account for the movement of IP during a timeframe 6312 in order to ensure IP does not inadvertently or mistakenly lapse due to failure to make a maintenance or annuity payment. This also helps ensure that the client 5304 is not authorizing the IP payment services provider 5306 to pay annuities on IP which the client no longer owns. It should be noted that when payment responses are due (whether in response to the set of payment decisions or the updated set of payment decisions), it does not necessarily mean that the payment responses are due immediately. For example, a client still has payment responses due prior to engaging in the ad hoc process (as exemplified by the contents within bracket 6330 of FIG. 4). Thus, by stating that the set of payment responses is due, it conveys that the set of payment decisions has been generated, providing the client 5304 with the opportunity to provide the set of payment responses. This also holds true for the updated set of payment decisions and the updated set of payment responses. Therefore, the set of payment decisions and the updated set of payment decisions should be considered to be a set of payment decision opportunities and an updated set of payment opportunities.

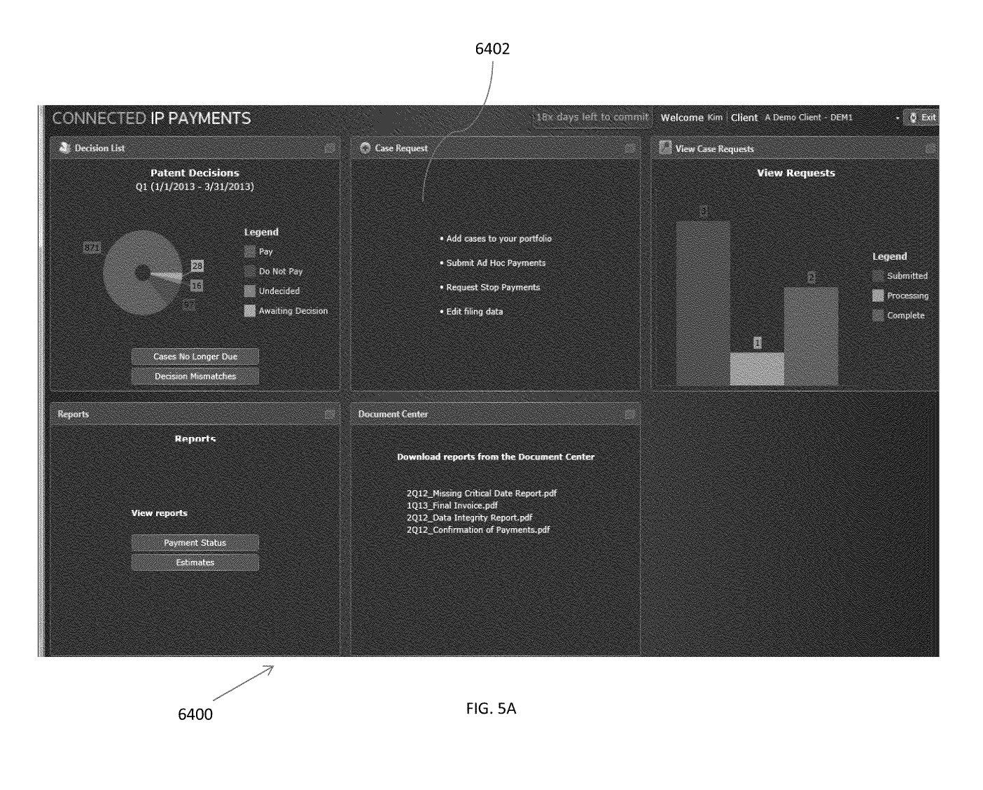

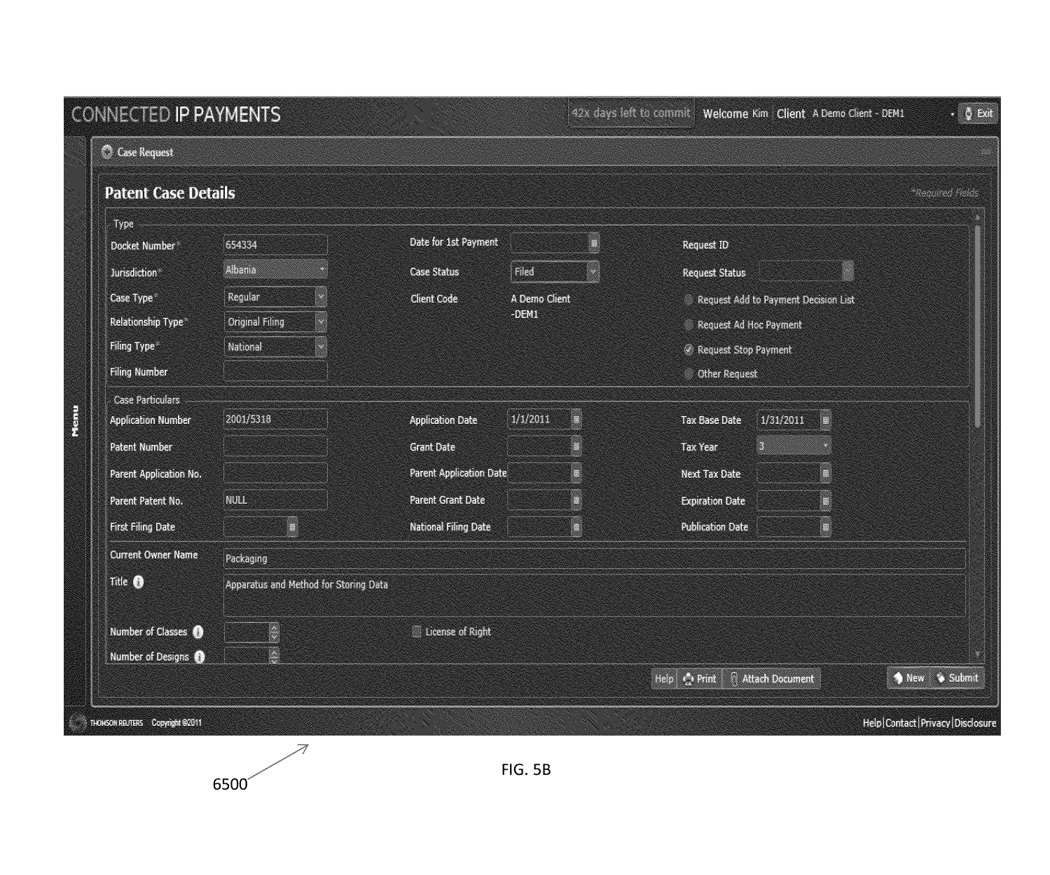

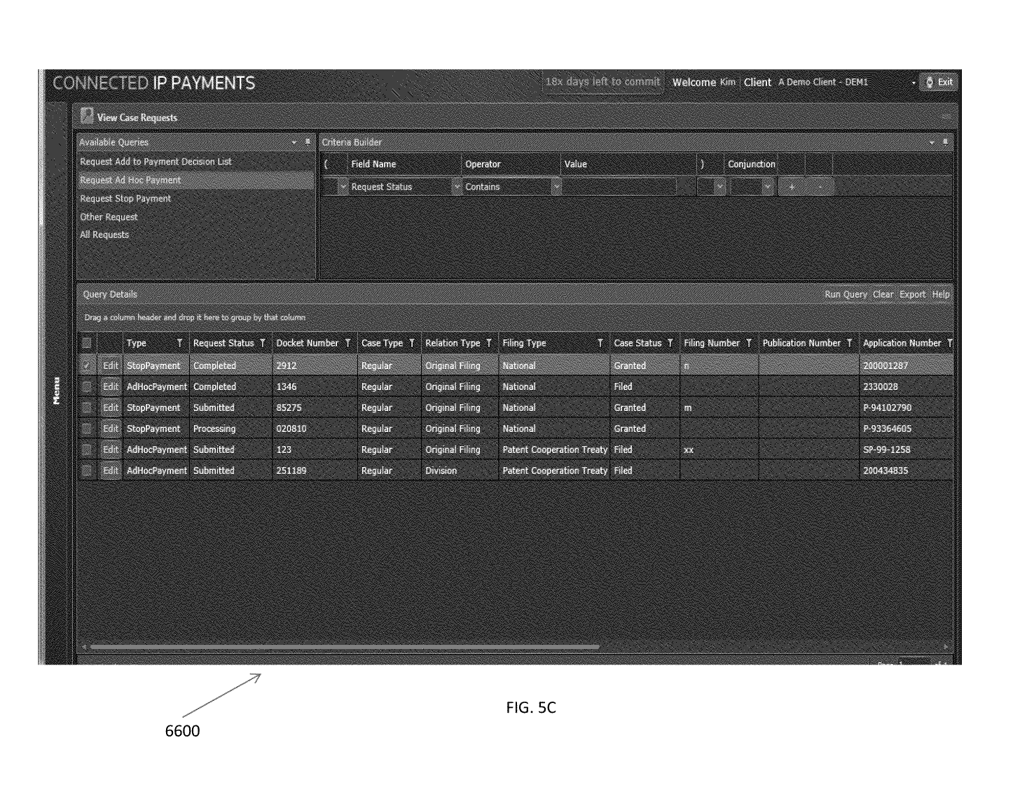

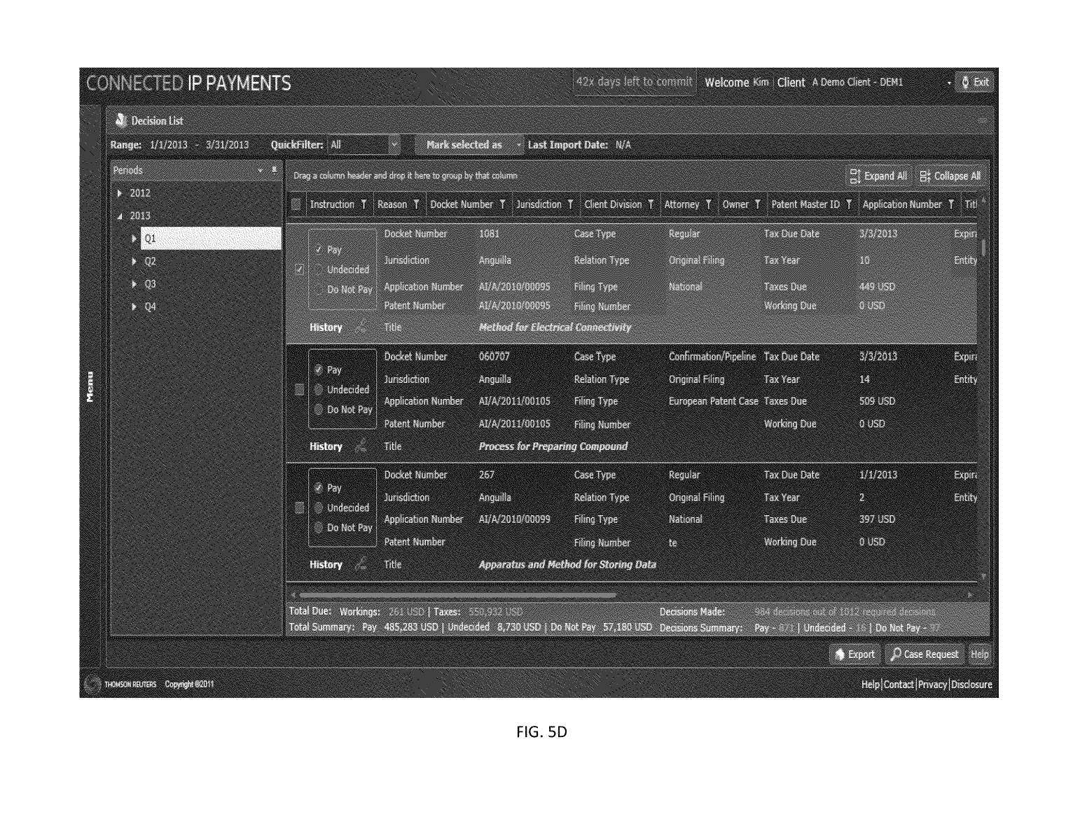

Referring to FIGS. 5a through 5d, the client 5304 may also accomplish the ad hoc process by accessing the AMS 104 directly, without logging into Thomson IP Manager®. This requires the client 5304 to enter a set of data relating to, e.g., newly acquired IP, newly divested IP, or both. The client 5304, through the AMS 104, may also provide new or updated instructions related to IP which has not been changed by the new business conditions and/or new laws or rule calculations mentioned above. Continuing with the assumptions and example with respect to FIG. 4, the client 5304 may log into the AMS 104, for example the Connected IP Payments platform of Thomson Reuters, at the second time. The client 5304 will see a dashboard 6400 as shown in FIG. 5a. In order add newly acquired IP (i.e., IP6 6326 and IP7 6328), the client 5304 clicks on a portion of the upper-middle section 6402 labeled “Add cases to your portfolio.” FIG. 5b shows a screen 6500 next seen by the client 5304. The screen requires the client to supply certain information. Each required information field in the screen 6500 is designated with a “*” symbol. The client 5304 would simply enter at least the required information for, e.g., IP6 6326 and click the “Submit” button on the lower right portion of the screen 6500. Once this is done, if the client 5304 clicks “New” the client is able to add another record whereas if the client 5304 clicks “Submit” the client will be returned to screen 6400. The client 5304 may also use the “Attach Document” button on the lower portion of FIG. 5b to upload a list of IP matters for processing. The uploaded list may take the form of, e.g., a spreadsheet with a predetermine format. At this point, the AMS 104 will apply the set of IP rules to, e.g., IP6 6326 to determine if an annuity is due during the time period 6314. If no annuity is due for IP6 6326 during the time period 6314, the information is simply stored by the AMS 104 with a “Pay” instruction for use with generating future sets of payment decisions. If an annuity is due for IP6 6326 during the time period 6314, clicking the “Submit” button on the lower right portion of the screen 6500 will both store the record in the AMS 104 and instruct the IP payment services provider 5306 to make an annuity payment with respect to IP6 6326 on behalf of the client 5304. This process may be repeated by the client 5304 until all of the newly acquired IP is processed. Next, and referring again to FIG. 5a, the client 5304 may continue with the ad hoc process by addressing the IP that was divested (e.g., IP1 6316 and IP2 6318) and/or IP for which a client 5304 has changed his/her mind regarding a decision to pay an annuity. Once at the dashboard 6400, the client clicks on the “Decision List” and is shown FIG. 5d. At this point, the client highlights one of the sets on information relating to the particular piece of IP for which the client 5304 no longer wishes to pay the annuity. Next, the client clicks the “Case Request” button in the lower right hand corner of FIG. 5d and is brought back to FIG. 5b. At this point, the client 5304 simply clicks the “Request Stop Payment” field and then clicks “Submit.” This instructs the IP payment services provider 5306 to stop payment on this particular piece of IP. However, if the payment has already been made, the AMS 104 will not permit the client 5304 to stop the payment and notify them of the same. As shown in FIG. 5c, the screen 6600 provides the client with information relating to the ad hoc process. For example, in the “Request Status” column, an entry of “Completed” indicates that the requested stop payment or submit payment instructions have been done. A “Submitted” entry in this column indicates that the IP payment services provider 5306 has received instructions but has yet to fully execute the instructions. Finally, a “Processing” entry in this column indicates the IP payment services provider 5306 is in the process of executing the instructions of the client 5304 but has yet to finish. When accomplishing the ad hoc process by accessing the AMS 104 directly, without logging into Thomson IP Manager®, it is recommended that the client 5304, at some point in the future, log into Thomson IP Manager® to update records for the newly acquired IP and the IP that was divested. In this embodiment, failure by the client to do this will not result in an inaccurate set of payment decisions for the next time period because the client has already provided the required information to the AMS 104. This is true even if the client 5304 elects, during the next round of annuity payments, to use an extraction file. This is because the set of annuity payments due based upon an extraction file from, e.g., a non-updated IP docketing system would not match the set of annuity payments due based upon information in the AMS 104 (due to the fact that the client 5304 previously updated the AMS records). In this case, the AMS 104 would alert the client 5304 of mismatched records, permitting the client 5304 to reconcile the information in AMS 104 with the information in the IP docketing system. However, failure to update records in Thomson IP Manager® may be disadvantageous for the client if they need to make other decisions with respect to the newly acquired IP and/or the IP that was divested. Such other decisions include, but are not limited to, whether to respond to an office action.

Having described for the ad hoc process a first embodiment (using a computer-based system such as server 6102 to generate an ad hoc extraction file which is communicated with AMS 104 by the client 5304) and a second embodiment (client interfaces with AMS 104 to enter information related to newly acquired IP and IP that was divested), a third embodiment is instructive. In the third embodiment, the AMS 104 may communicate directly with IP docketing system of the server 6102 in client system 106. This may be done by transmitting instructions directly between the AMS 104 and IPMM 6100 in response to events in the AMS 104 and IPMM 6100. As will be appreciated by those skilled in the art, this may be accomplished through, e.g., API calls, RESTful services, and other techniques that transmit data and instructions securely across a communication network. For example, recording the grant of an EPC patent application in Thomson IP Manager® could automatically transmit to the AMS 104 both a “Stop Payment” instruction related to the original European patent application and a series of ad hoc “Pay” requests related to the resulting national patents. In addition, manual updates (e.g., “Stop Payment” instructions) entered in the AMS 104 could be transmitted to Thomson IP Manager® and used to automatically update the associated record, ensuring that records remain consistent and synchronized across various systems

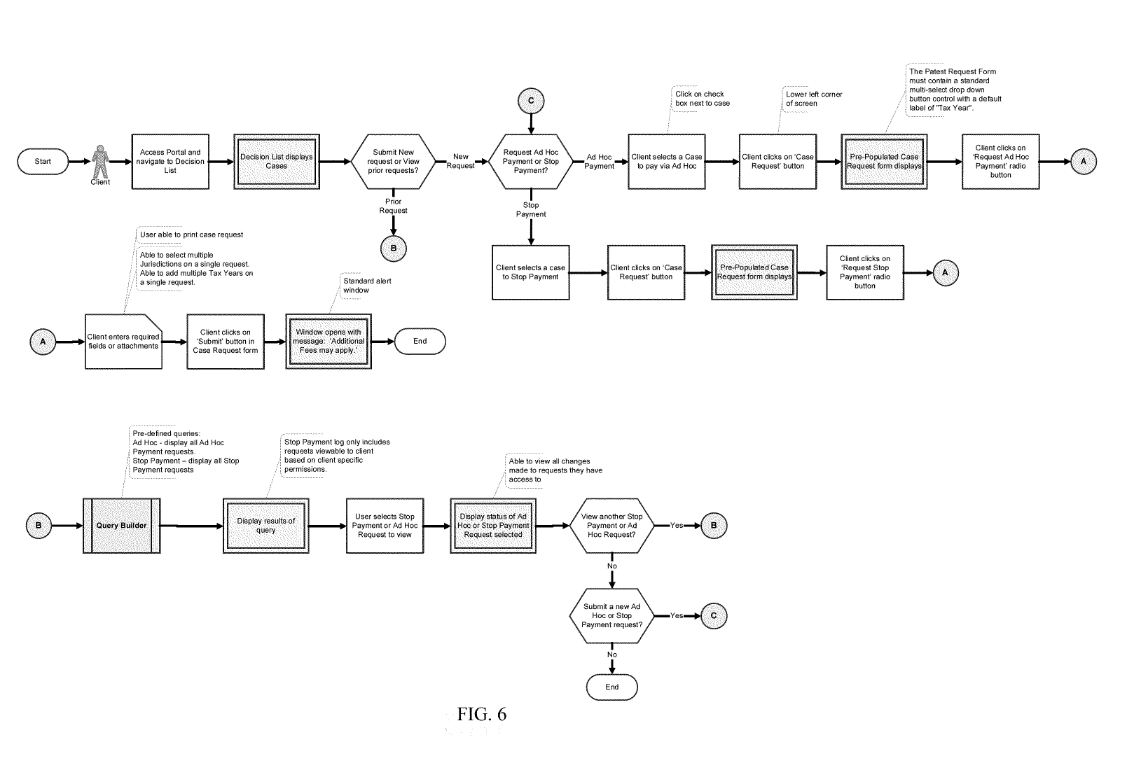

Referring to FIG. 6, a flowchart representing the process by which the ad hoc decisions of a client are processed by an IP payment services provider is shown. FIG. 6 may encompass any one of the three embodiments described above.

The detailed description of the invention has been described by referencing three embodiments. Those skilled in the art will realize that there are many variations, even within the various embodiments, and that the embodiments described above are intended only to illustrate and teach one or more ways of practicing or implementing the present invention, not to restrict its breadth or scope. For example, in the first and third embodiments, the change is necessarily detected in the IP docketing system whereas in the second embodiment the change is simply detected in the AMS 104. Further, and with respect to all embodiments, one variation is that the client 5304 may have any number of pieces of IP. Yet another variation is that the client 5304, when interacting with the AMS, may authorize or de-authorize annuity payments on the basis of more than one piece of IP. A non-exhaustive list of examples includes examples wherein the client may authorize/de-authorize based upon: (1) an entire patent/trademark/application family; (2) a particular country (e.g., pay all annuities on everything in the U.S., pay all annuities on all patent applications in France, etc. . . . ); and (3) a particular date (e.g., let all patents issued prior to a certain date lapse, pay all renewals on all trademarks in the U.K. registered within the past five years, etc. . . . ). Yet another variation is that the relation of the BPC, the timeframe 6312 and the time period 6314 may change with respect to the first quarter 6304, the second quarter 6306, the third quarter 6308 and the fourth quarter 6310 as long as the BPC occurs prior to the timeframe 6312 which occurs prior to the time period 6314. Finally, those skilled in the art will appreciate that when a client 5304 uses the ad hoc process: (1) if the BPC is complete and the client 5304 is a “pay all” or “pay select” client, information will be added to the AMS 104, no new set of payment decisions will be generated, and the ad hoc payment will be made on behalf of the client 5034; and (2) if the BPC is not yet done, for “pay all” clients, information will be added to the AMS 104 and an automatic “Pay” designation will be used for appropriate records whereas for “pay select” clients, information will be added to the AMS 104, providing the opportunity for the client 5304 to provide a response. Thus, the actual scope of the invention is defined by the appended claims and their equivalents.

What we claim is:

1. An automated computer implemented method comprising:
(1) identifying a time period prior to a first time;
(2) based on the time period, generating a set of payment decisions for which a set of payment responses is due and is associated with the time period, the set of payment decisions being associated with a first set of intellectual property, the first set of intellectual property being associated with an IP docketing system;
(3) during a timeframe, detecting a change at a second time, the change impacting the set of payment decisions, the second time being after the first time and prior to the beginning of the time period;
(4) determining that the change has rendered the set of payment decisions inaccurate;
(5) based on the change, generating an electronic signal indicative of an updated set of payment decisions for which an updated set of payment responses is due and is associated with the time period, the updated set of payment decisions being associated with a second set of intellectual property; and
(6) transmitting the electronic signal.

2. The method of claim 1 wherein the second time is prior to a first due date of the updated set of payments decisions.

3. The method of claim 2 wherein the first due date is a due date on which a first payment from the updated set of payment decisions is due.

4. The method of claim 2 further comprising:
(1) receiving a set of updated payment responses; and
(2) processing the set of updated payment responses to initiate a set of payments associated with the second set of intellectual property.

5. The method of claim 1 wherein the time period is one month.

6. The method of claim 1 wherein the time period is three months.

7. The method of claim 1 wherein the time period is six months.

8. The method of claim 1 wherein the time period is one year.

9. The method of claim 1 wherein the time period is client dependent.

10. The method of claim 1 wherein the step of generating the set of payment decisions is based upon an extraction file relating to the first set of intellectual property.

11. The method of claim 10 wherein the step of generating the set of payment decisions is based upon a final extraction file relating to the first set of intellectual property.

12. The method of claim 11 wherein the step of detecting is based upon an ad hoc extraction file which is generated after the final extraction file.

13. The method of claim 1 wherein the step of detecting is based upon entry of a set of data into an annuity management system.

14. The method of claim 13 wherein the set of data comprises a newly acquired piece of IP.

15. The method of claim 13 wherein the set of data comprises a newly divested piece of IP.

16. The method of claim 13 wherein the set of data comprises data relating to a piece of IP which has undergone a change in status.

17. The method of claim 1 wherein in response to transmitting the electronic signal, the transmitting occurring within an annuity management system, the annuity management system is able to provide an interface comprising the updated set of payment decisions, permitting a client to enter an updated set of payment responses.

18. An automated computer-based system comprising:
(1) a processor;
(2) a memory coupled to the processor;
(3) a program stored in the memory for execution by the processor, the program, upon execution, causing the automated computer-based system to:
(a) identify a time period prior to a first time;
(b) based on the time period, generate a set of payment decisions for which a set of payment responses is due and is associated with the time period, the set of payment decisions being associated with a first set of intellectual property, the first set of intellectual property being associated with an IP docketing system;
(c) during a timeframe, detect a change at a second time, the change impacting the set of payment decisions, the second time being after the first time and prior to the beginning of the time period;
(d) determine that the change has rendered the set of payment decisions inaccurate;
(e) based on the change, generate an electronic signal indicative of an updated set of payment decisions for which an updated set of payment responses is due and is associated with the time period, the updated set of payment decisions being associated with a second set of intellectual property; and
(f) transmit the electronic signal.

19. The computer-based system of claim 18 wherein the second time is prior to a first due date of the updated set of payments decisions.

20. The computer-based system of claim 19 wherein the first due date is a due date on which a first payment from the updated set of payment decisions is due.

21. The computer-based system of claim 19 further configured to:
(1) receive a set of updated payment responses; and
(2) process the set of updated payment responses to initiate a set of payments associated with the second set of intellectual property.

22. The computer-based system of claim 18 wherein the time period is one month.

23. The computer-based system of claim 18 wherein the time period is three months.

24. The computer-based system of claim 18 wherein the time period is six months.

25. The computer-based system of claim 18 wherein the time period is one year.

26. The computer-based system of claim 18 wherein the time period is client dependent.

27. The computer-based system of claim 18 wherein the generation of the set of payment decisions is based upon an extraction file relating to the first set of intellectual property.

28. The computer-based system of claim 27 wherein the generation of the set of payment decisions is based upon a final extraction file relating to the first set of intellectual property.

29. The computer-based system of claim 28 wherein the detection is based upon an ad hoc extraction file which is generated after the final extraction file.

30. The computer based system of claim 18 wherein the detection of the change at the second time is based upon entry of a set of data into an annuity management system.

31. The computer based system of claim 18 wherein the set of data comprises a newly acquired piece of IP.

32. The computer based system of claim 18 wherein the set of data comprises a newly divested piece of IP.

33. The computer-based system of claim 30 wherein the set of data comprises data relating to a piece of IP which has undergone a change in status.

34. The computer-based system of claim 18 wherein execution of the program, causing transmission of the electronic signal within an annuity management system, further causes the automated computer-based system to provide an interface comprising the updated set of payment decisions and permit acceptance of the updated set of payment responses.
